(19) United States
(12) Patent Application Publication
(10) Pub. No.: US 2024/0235399 A1
(43) Pub. Date: Jul. 11, 2024

(54) POWER SWITCHING REGULATOR FOR SWITCHING FREQUENCY AVOIDANCE

(71) Applicant: Atmosic Technologies, Inc., Campbell, CA (US)

(72) Inventor: Manolis Terrovitis, Athens (GR)

(73) Assignee: Atmosic Technologies, Inc., Campbell, CA (US)

(21) Appl. No.: 18/532,976

(22) Filed: Dec. 7, 2023

Related U.S. Application Data
(60) Provisional application No. 63/437,183, filed on Jan. 5, 2023.

(51) Int. Cl. H02M 3/158; H02M 3/157

(52) U.S. Cl. CPC H02M 3/1582; H02M 3/157

(57) ABSTRACT

Implementations are disclosed for controlling a discontinuous mode power switching regulator to avoid specific switching frequencies by the regulator that may cause interference. A controller may be configured to operate in different modes to cause the switching regulator to energize and dump the inductor at different rates based on a frequency of requests to energize the inductor. The controller is to receive a plurality of requests to energize the inductor and generate a control signal based on the plurality of requests (with the control signal causing a first number of switching events at the switching regulator over a defined time period). The controller is to also determine whether a switching frequency of the switching regulator is an undesired switching frequency and switch from the first mode to a second mode (with the control signal generated while in the second mode causing the switching frequency of the switching regulator to change).

### CROSS-REFERENCE TO RELATED APPLICATIONS

This patent application claims priority to U.S. Provisional Patent Application No. 63/437,183 entitled “POWER SWITCHING REGULATOR FOR SWITCHING FREQUENCY AVOIDANCE” and filed on Jan. 5, 2023, which is assigned to the assignee hereof. The disclosures of all prior applications are considered part of and are incorporated by reference in this patent application.

### TECHNICAL FIELD

The present implementations relate generally to power switching regulators, and specifically to controlling a discontinuous mode power switching regulator to avoid specific switching frequencies.

### BACKGROUND OF RELATED ART

Various electronic devices include a power circuit to provide DC power of specific voltages (such as via one or more power rails from the power circuit) to different electronic components of the device. The power circuit receives power from a power source, such as a battery or an AC power source after AC to DC conversion. The received power may be of a different voltage than needed or may need to be stabilized to ensure that power having a stable voltage level is provided on the one or more power rails. The power circuit thus may include one or more power switching regulators (also referred to as switching regulators) to regulate the power for the one or more power rails.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a device including a switching regulator and a controller coupled to the switching regulator. The switching regulator is to provide power on one or more power rails from one or more power supplies. The switching regulator is a discontinuous mode switching regulator, and the switching regulator is associated with an inductor to energize and dump to maintain a stable voltage for power on the one or more power rails. The controller is to control the switching regulator. The controller is configured to receive, while in a first mode, a plurality of requests to energize the inductor. The controller is also configured to generate a control signal based on the plurality of requests. The control signal causes a first number of switching events at the switching regulator over a defined time period. The controller is further configured to determine whether a switching frequency of the switching regulator over the defined time period is an undesired switching frequency and switch from the first mode to a second mode based on the switching frequency being the undesired switching frequency. The control signal generated by the controller while in the second mode causes the switching frequency of the switching regulator to change.

Another innovative aspect of the subject matter described in this disclosure can be implemented as a method of controlling, by a controller, a switching regulator. The method includes receiving, while in a first mode, a plurality of requests to energize an inductor associated with the switching regulator. The method also includes generating a control signal based on the plurality of requests. The control signal causes a first number of switching events at the switching regulator over a defined time period. The method further includes determining whether a switching frequency of the switching regulator over the defined time period is an undesired switching frequency and switching from the first mode to a second mode based on the switching frequency being the undesired switching frequency. The control signal generated by the controller while in the second mode causes the switching frequency of the switching regulator to change.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

Aspects of the present disclosure are illustrated by way of example and are not intended to be limited by the figures of the accompanying drawings.

FIG. 1A shows a block diagram of a buck converter.

FIG. 1B shows a block diagram of a boost converter.

FIG. 1C shows a block diagram of a buck-boost converter.

FIG. 2 shows a timing diagram of inductor current for an inductor switching states between energizing and dumping and an output supply ripple caused by such state switch for boost or buck-boost.

FIG. 3 shows a timing diagram of inductor current change for an inductor energizing and dumping at a frequency.

FIG. 4 shows a block diagram of a power circuit including a switching regulator and a controller to control the switching regulator.

FIG. 5 shows a block diagram of an example controller to control a switching regulator.

FIG. 6 shows a timing diagram of an inductor energizing and dumping based on a controller being in a first mode versus a second mode when controlling a switching regulator associated with the inductor.

FIG. 7 shows an illustrative flow chart depicting an example operation of a controller controlling a switching regulator.

Like numbers reference like elements throughout the drawings and specification.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device that includes a discontinuous mode switching regulator that provides one or more power rails for powering device components.

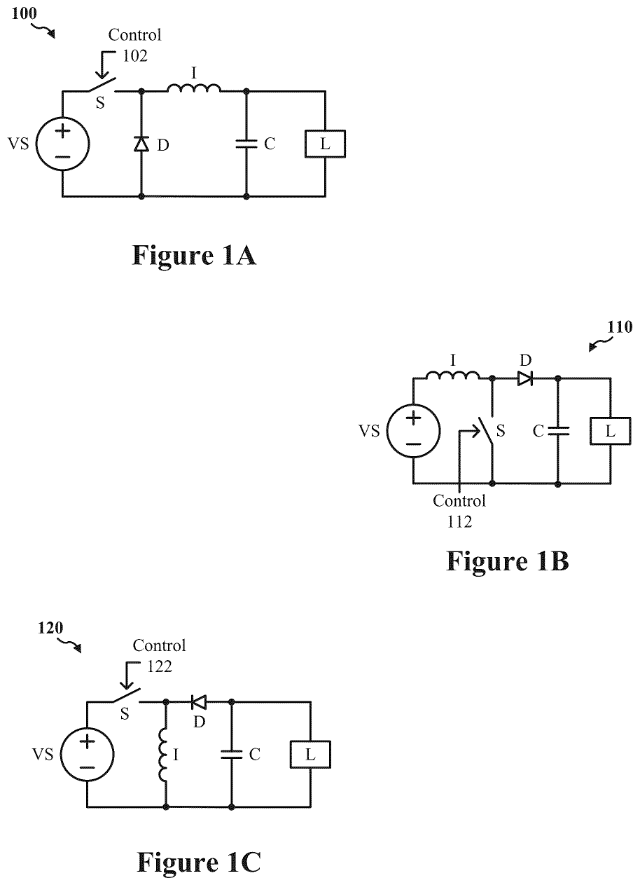

A switching regulator may be used in power circuits to regulate a power from a power supply (such as from a battery or from an AC circuit after AC to DC conversion) such that one or more powers at stable voltage levels are provided via one or more power rails. In regulating the power from a power supply, a switching regulator may increase or decrease the voltage level to a desired voltage level for a specific power rail. To regulate the power to output a power at a stable voltage level, an inductor associated with the switching regulator may be energized (are charged) to increase the magnetic energy stored in the inductor and subsequently dumped (are discharged) to decrease the magnetic energy stored in the inductor. A discontinuous mode switching regulator refers to a switching regulator that has moments during which the inductor is idle (i.e., neither energizing nor dumping energy). FIGS. 1A-1C are simplified example circuits for adjusting a voltage level from a power supply (referred to in FIGS. 1A-1C as a voltage supply) to a power rail (which is depicted in FIGS. 1A-1C with reference to a load coupled to such a power rail) based on energizing and dumping energy by an inductor of the circuit. Each circuit may operate in a discontinuous mode, with the inductor being idle at certain times.

FIG. 1A shows a block diagram of a buck converter 100. A buck converter 100 reduces a voltage level from the voltage supply VS provided to the load L. The switch S enables the buck converter 100 to operate in a discontinuous mode. In particular, when S is open and the inductor I is discharged, I remains in an idle state until S is closed based on control signal 102.

FIG. 1B shows a block diagram of a boost converter 110. A boost converter 110 increases a voltage level from the voltage supply VS provided to the load L. The switch S enables the boost converter 110 to operate in a discontinuous mode. In particular, when S is open and the inductor I is discharged, I remains in an idle state until S is closed based on control signal 112.

FIG. 1C shows a block diagram of a buck-boost converter 120. A buck-boost converter 110 may increase or decrease a voltage level from the voltage supply VS provided to the load L. The switch S enables the buck-boost converter 120 to operate in a discontinuous mode. In particular, when S is open and the inductor I is discharged, I remains in an idle state until S is closed based on control signal 122.

The control signals 102, 112, and 122 may be generated in any suitable manner. For example, a comparator may compare the voltage level supplied to L to a reference voltage (VREF) to ensure that a desired voltage level is maintained. For example, the output of the comparator may cause a switching event at the switching regulator to maintain the voltage level on the power rail at VREF (which may include changing the state of switch S in any of the depicted voltage converters). To note, the process of transferring energy from a power source (e.g., voltage source VS) to a destination (e.g., load L) via the inductor I involves a sequence of states of one or more switches included in the switching regulator (e.g., switch S) and is referred to herein as a switching event of the switching regulator.

For each of the voltage converters, there may be an idle time (during which the inductor I is idle), an energize time (during which the inductor I is charging), and a dump time (during which the inductor I is discharging). Energize and charge may be used interchangeably herein, and dump and discharge may also be used interchangeably herein with reference to an inductor for a switching regulator.

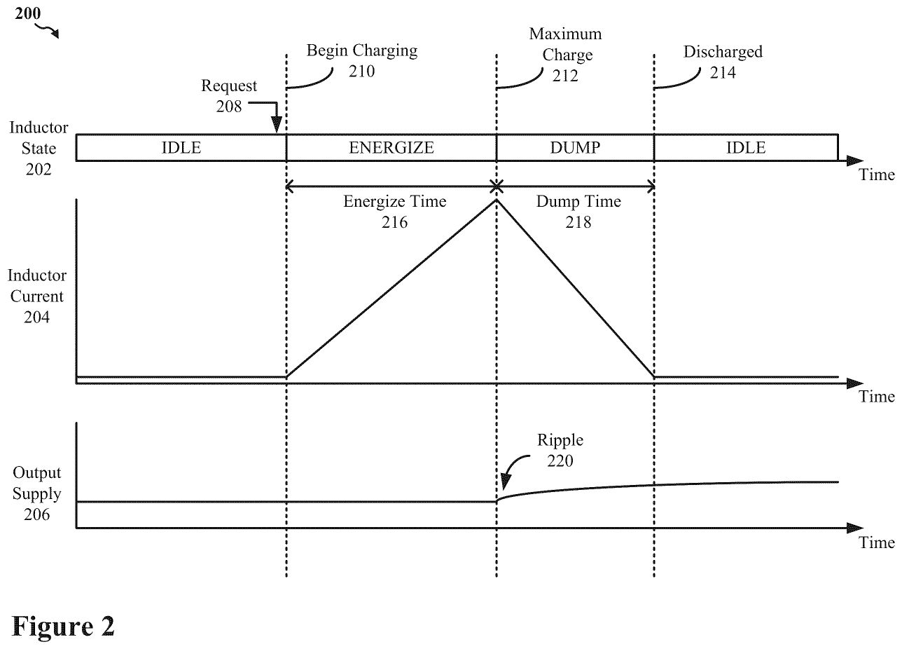

With every switching event, charge is transferred to the output supply to cause a ripple on the output supply from the switching regulator. FIG. 2 shows a timing diagram 200 of inductor current 204 for an inductor switching states between energizing and dumping and an output supply ripple caused by such state switch. FIG. 2 is described with reference to the boost converter 110 in FIG. 1B or the buck-boost converter 120 in FIG. 1C for clarity. The inductor I has different inductor states 202 of an idle state (IDLE), an energize state (ENERGIZE), and a dump state (DUMP). The inductor I is in an idle state when the switch S is open and the inductor I is discharged (thus not storing energy). A request 208 may be received to indicate that the inductor is to be charged. For example, a comparison of the voltage output to the load L to a VREF may cause a request for a switching event to occur to maintain a desired voltage level at VREF. As such, the control signal 112 causes the switch S to close at the begin charging time instance 210, and the inductor state 202 switches from IDLE to ENERGIZE.

The inductor I charges during energize time 216 (with the amount of energy stored in the inductor I increasing) until the maximum charge time instance 212 when a maximum inductor current is reached and the amount of energy stored at the inductor I is maximized. To note, inductor current (referred to as a) increases linearly over time when the voltage V across inductor I is constant, and the energy E stored at inductor I with inductance b and current a is

$$E = \frac{1}{2} a {b}^{2}$$

(which increases quadratically over time). The maximum charge time instance 212 is typically based on the maximum current for the inductor multiplied by the inductance of the inductor and divided by the voltage across the inductor, which for the boost and the buck-boost case is the input voltage. In other words, once the maximum current is reached for the inductor I (which is based on the input voltage from the voltage source VS and the inductance of the inductor I), the voltage converter switches from charging the inductor to discharging the inductor (i.e., DUMP for the inductor I), such as by opening the switch S. During the dump time 218 (when the switch S is open), the inductor I discharges energy. FIG. 2 depicts the inductor I completely discharging to thus reach IDLE before the switch S closes again to begin a new energize time.

As depicted by the timing diagram for the output supply 206 of the switching regulator, there is a ripple 220 in the output supply 206 from the switching regulator. Such a ripple may cause interference or otherwise negatively affect the performance of components powered by the power rails provided by the switching regulator (such as the device components represented by the load L in FIG. 1B). In addition, such switching noise from the ripples can couple to nearby sensitive circuits via, e.g., electromagnetic interference and substrate coupling. In general, the power circuit may be configured to attempt to reduce the ripple 220 so as not to interfere with operation of device components and circuits.

However, device components may be more sensitive to interference at specific frequencies as compared to at other frequencies. For example, for a transmission device that transmits at specific frequencies, the transmission device may be more sensitive to interference generated by a switching regulator at the transmission frequency or at a frequency whose harmonic coincides with the transmission frequency than compared to interference generated at a different frequency. In another example, if a device uses a piezoelectric crystal or other suitable clock component having a defined resonant frequency (such as a 60 megahertz (MHz) crystal), the device may be more sensitive to interference generated by the switching regulator at the defined frequency or at a frequency whose harmonic coincides with the defined frequency than at a different frequency.

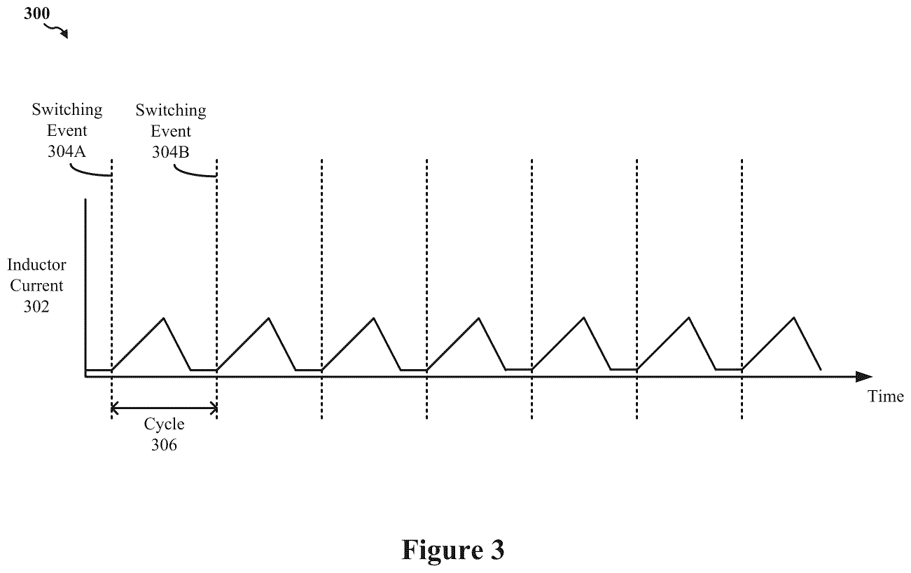

FIG. 3 shows a timing diagram 300 of inductor current change for an inductor energizing and dumping at a frequency. The inductor current 302 changes over time. Switching events 304A and 304B indicate when, e.g., the switch S of the boost converter 110 (or buck converter 100, or buck-boost converter 120) is closed so that the inductor is in an energize state. Once a maximum inductor current is reached, the inductor is in a dump state until discharged. The inductor is thus in an idle state until the next switching event. The time between entering successive energize states is depicted as cycle 306.

The interference from the switching regulator may be at a frequency that is the number of cycles 306 over a defined amount of time. While the switching events are depicted in FIG. 3 as being uniformly spaced (with the cycles 306 being of the same time length), the switching events may be at nonuniform times (such as having slight variations such that the cycles 306 slightly differ in time length). However, the switching regulator may generate interference at an average frequency even with slight variations in switching event spacing, and interference at the average frequency may still cause problems if the average frequency is an undesired frequency. As such, there is a need to prevent a switching regulator from generating interference at an undesired frequency that is sensitive to the device components.

As described herein, operation of a switching regulator is controlled to prevent interference from being generated by the switching regulator at an undesired frequency to which the device is sensitive (such as at a transmission frequency, at a clock frequency, or at a harmonic of one of those frequencies or at a frequency whose harmonic coincides with the transmission frequency or the clock frequency). In some implementations, a controller is configured to determine whether the frequency of switching events at the switching regulator (the switching frequency), which indicates the frequency of the ripples based on the frequency an inductor charges and discharges, is an undesired frequency defined for the device. If the switching frequency is the undesired frequency, the controller is configured to adjust the inductor charge and discharge frequency by, e.g., adjusting one or more of an energize time, a dump time, or a maximum current of the inductor. For example, the controller may cause a state change in one or more switches so that the inductor switches from an energize state to a dump state before an otherwise maximum inductor current is reached. If a dump state is entered before an otherwise maximum inductor current is reached, the amount of energy dumped by the inductor during one cycle decreases. In some implementations, the controller may control the switching regulator to charge and discharge the inductor a greater number of times during a time period in order to compensate for the reduced energy discharged during one cycle.

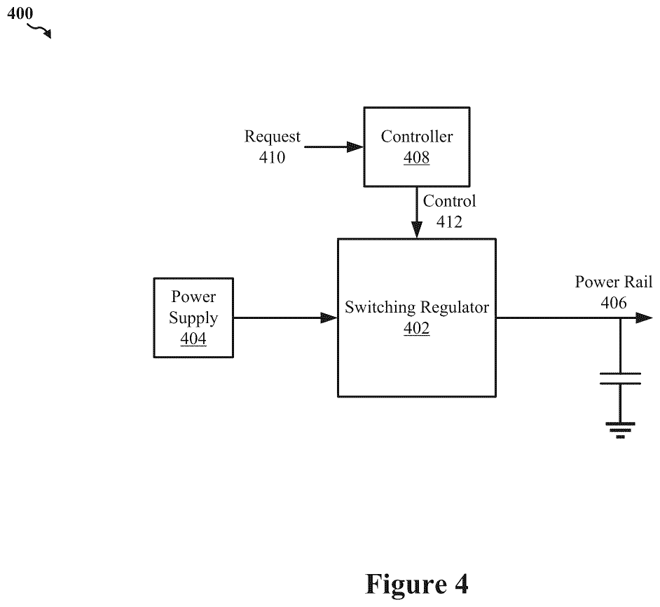

FIG. 4 shows a block diagram of a power circuit 400 including a switching regulator 402 and a controller 408 to control the switching regulator 402. While the controller 408 is depicted as separate from the switching regulator 402 for clarity in explaining aspects of the present disclosure, in some implementations, the controller 408 is part of the switching regulator 402. As such, reference to a controller 408 and switching regulator 402 may refer to different portions of the switching regulator (such as the switching regulator 402 referring to a switch matrix portion of the switching regulator 402 used to control power regulation on one or more power rails). Therefore, referring to the “controller” in this disclosure does not require a separate component from the switching regulator itself. The switching regulator 402 is configured to receive power from a power supply 404 and provide power regulated by the switching regulator 402 on power rail 406. The power supply 404 may be one or a plurality of power supplies coupled to the switching regulator 402, and the switching regulator 402 may be a single or multi-input switching regulator. In addition, the power rail 406 may be one or a plurality of power rails provided by the switching regulator 402, and the switching regulator 402 may be a single or a multi-output switching regulator.

The switching regulator 402 is a discontinuous mode switching regulator controlled, e.g., by control signal 412 generated by the controller 408. For example, referring back to FIG. 1B, the controller 408 may be configured to generate the control signal 112 to control the switch S in order to switch the inductor I between energize state and dump state (and idle state). The controller 408 may be configured to generate the control signal 412 based on the request(s) 410 received. The request(s) 410 may be the same as request 208 described above with reference to FIG. 2 or otherwise when to energize the inductor for the switching regulator 402.

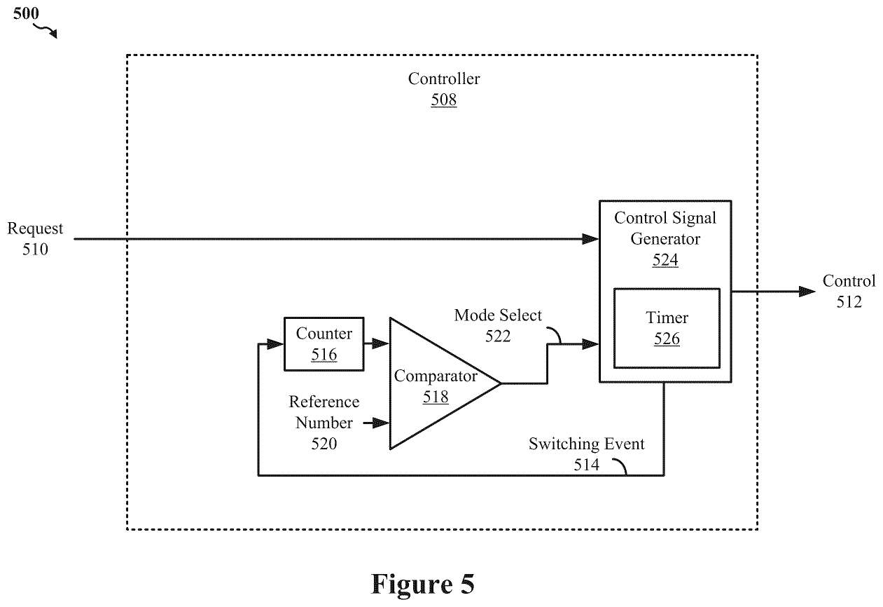

In some implementations, the switching regulator 408 is configured to control a switching frequency of the switching regulator 402 via the control signal 412 to prevent the switching regulator 402 from generating interference at an undesired frequency for a device including the power circuit 400. The undesired frequency may be predefined for the device. For example, the undesired frequency may be defined as a transmission frequency (or a frequency whose harmonic equals the transmission frequency) of the device. In another example, the undesired frequency may be defined as a clock frequency (or a frequency whose harmonic equals the clock frequency) of the device. An example configuration and operation of the controller 408 is depicted in and described with reference to FIG. 5.

FIG. 5 shows a block diagram 500 of an example controller 508 to control a switching regulator. The controller 508 may be an example implementation of the controller 408 in FIG. 4, and the switching regulator to be controlled may be the switching regulator 402 in FIG. 4. As such, the request(s) 510 input to the controller 508 may be an example implementation of the request(s) 410 in FIG. 4, and the control signal 512 may be an example implementation of the control signal 412 in FIG. 4. As noted above, the controller 508 and the switching regulator 402 (such as the switch matrix of a switching regulator) may be part of the same switching regulator, and FIG. 5 depicts a controller 508 separate from a switching regulator 402 exclusively for clarity is describing aspects of the present disclosure.

The controller 508 includes a control signal generator 524 to generate the control signal 512 and components 516-518 to determine whether the switching frequency of the switching regulator is an undesired switching frequency. The components 516-518 include a counter 516 that counts switching events over a defined time period (such as a window of time that includes several switching events) and a digital comparator 518, whose operations are described in more detail below.

The controller 508 is configured to operate in a plurality of modes. For example, in a first mode, the control signal generator 524 may be configured to generate the control signal 512 as conventionally performed for a switching regulator, such as switching from an energize state to a dump state for an inductor when reaching a maximum inductor current. In the first mode, the charge and discharge rate of the inductor may be fixed based on the power source and the inductor. For a fixed maximum inductor current, the energize time and the dump time may also be fixed based on the charge and discharge rate of the inductor. The timer 526 may be configured to measure the time since causing the switching event to transition to the energize time up to the length of the known energize time. For example, the timer 526 may include a counter to count to a fixed number n associated with the length of the energize time, with the rate at which n is counted being based on a clock rate of the device including the controller 508. Once the timer measures the energize time (such as the counter counting to n), the control signal generator 524 may generate the control signal 512 to cause a switching event at the switching regulator such that the inductor transitions from an energize state to a dump state (e.g., by opening the switch S in the boost converter 110).

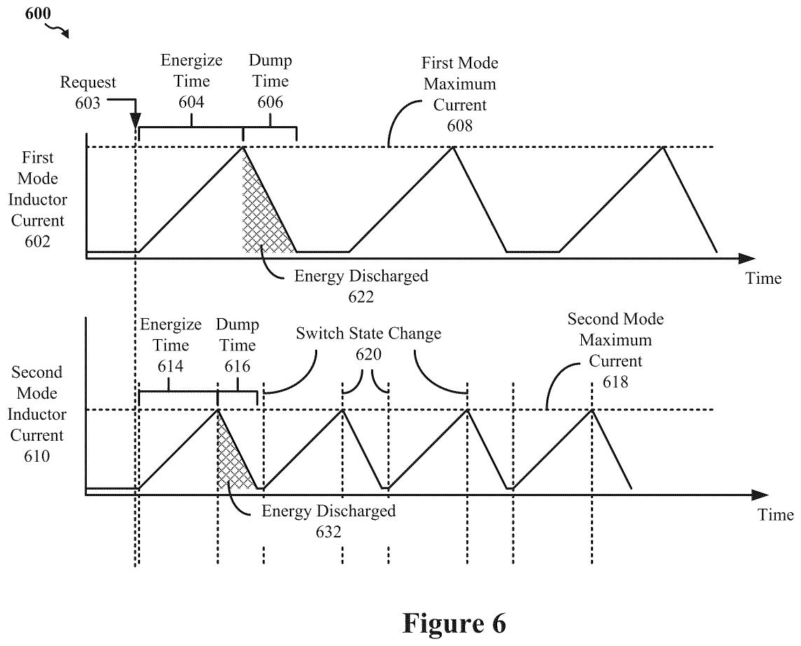

If the switching frequency of the switching regulator is determined by the controller 508 to be an undesired frequency, the controller 508 may switch to a second mode. In the second mode, the control signal generator 524 may be configured to generate the control signal 512 to adjust one or more of the energize time, the dump time, or the maximum current of the inductor. In some implementations, the control signal generator 524 generates the control signal 512 to cause the inductor to transition from the energize state to the dump state before the end of the energize time used for the first mode. For example, the control signal generator 524 may shorten the energize time from the first mode to the second mode by a defined percentage (such as 70 percent). If the timer 526 includes a counter to count to n for the energize time in the first mode, the timer 526 may configure the counter (or use a different counter) to count to 0.7 times n (i.e., 0.7*n). For example, if n is 100, the counter may count to 100 in the first mode before the control signal 512 indicates that the switch S in the boost converter 110 is to be opened, and the counter may count to 70 in the second mode before the control signal 512 indicates that the switch S in the boost converter 110 is to be opened. Adjusting the energize time and/or the dump time and/or the maximum inductor current between modes is described with reference to FIG. 6.

FIG. 6 shows a timing diagram 600 of an inductor energizing and dumping based on a controller being in a first mode versus a second mode when controlling a switching regulator associated with the inductor. The timing diagram 600 in FIG. 6 is described with reference to the controller 508 in FIG. 5 and the switching regulator 402 in FIG. 4. The timing diagram 600 shows two graphs: the inductor current based on the controller in the first mode (the first mode inductor current 602) and the inductor current based on the controller in the second mode (the second mode inductor current 610). For the controller 508 in the first mode, the inductor for the switching regulator 402 may enter an energize state based on the request 603 causing the controller 508 to generate the control signal 512 to cause a switching event at the switching regulator 402 to transition the inductor to an energize state.

The inductor remains in the energize state (such as the switch S of the boost converter 110 remaining closed) for the energize time 604, which may be based on the charge rate of the inductor and the maximum inductor current. The first mode maximum current 608 is the maximum current at the inductor before the inductor is to transition from the energize state to the dump state. At the end of the energize time 604 (such as reaching the maximum inductor current), the inductor transitions to the dump state. For example, a counter of the timer 526 may count to n, with n being based on the length of the energize time associated with the maximum inductor current. Once the counter reaches n, the control signal generator 524 may generate the control signal 512 to cause a switching event such that the inductor transitions to the dump state (such as the switch S of the boost converter 110 being opened). The dump time 606 is the time to dump from the maximum energy 608 to zero at the inductor. As noted above, the dump time 606 may be based on the maximum energy 608 and the discharge rate of the inductor.

As noted above, an undesired frequency may be defined for the device including the controller 508 and the switching regulator 402. For example, the power circuit 400 may be included in a transmission device that is sensitive to interference at a frequency that interferes with transmission. The undesired frequency may be determined by the device manufacturer or a user through use of a test bench or during observance of real world operation of the device. As such, the undesired frequency may be known for the device in order to configure the controller 508 to cause the switching regulator 402 to prevent interference at the undesired frequency.

Referring back to FIG. 5, the controller 508 may determine if the switching regulator's switching frequency (which causes ripples on the output supply at the switching frequency) is the undesired frequency. In some implementations, the controller 508 counts, via the counter 516, the number of switching events 514 over a defined time period. While not depicted in FIG. 5, the defined time period may be based on a clock signal or another control signal provided to the counter 516. Such a signal may be used to reset the counter to begin a new count for a new time period when a previous time period completes. In some other implementations, instead of resetting the counter, such a signal may be used to define a sliding time window in which the counter counts switching events.

For example, a 32 kilohertz (kHz) clock may be used to define the start and end of the defined time period based on a number of clock cycles of the clock, or the number of clock cycles may define the length of the sliding time window. In a simplified example, a digital logic attached to the clock may generate a control signal to reset the counter 516 every 10th clock cycle from the 32 kHz clock or to define a time window that is 10 clock cycles long. In this manner, the counter 516 may count the number of switching events each time period that is approximately three ten-thousandths of a second. The digital logic may be programmable or otherwise tuned to allow any number of clock cycles to be defined such that the defined time period may be configured to a desired length. At the end of the time period during which the counter 516 counts the switching events 514, the counter 516 may provide the count to the comparator 518. For example, a buffer between the counter 516 and the comparator 518 may be configured to pass the count from the counter 516 only at the end of the determined time period (such as based on the signal from the digital logic to indicate the end of the time period). In another example, the counter counts to the end of the time window and passes the count to the comparator 518 after counting.

The comparator 518 may be configured to compare the count of switching events 514 from the counter 516 to a reference number 520 of switching events associated with the undesired frequency. The reference number 520 may be determined as the defined time period divided by the known undesired frequency to indicate the number of switching events during the defined time period to cause interference at the undesired frequency. In some implementations, the reference number 520 may be programmable or adjustable based on, e.g., the device including the controller 508 and the switching regulator 402. For example, if a similar power circuit 400 is to be included in two different devices associated with two different, known undesired frequencies, the device manufacturer may calculate and program the reference number 520 specifically for the device including that power circuit 400.

As long as the count from the counter 516 does not match the reference number 520 (such as being outside a threshold of the reference number 520), the mode select signal 522 from the comparator 518 does not cause the controller to switch to the second mode. For example, the mode select signal 522 may remain logic 0 to indicate that the controller is to remain in the first mode, and the energize time of the inductor may remain the same length as the timer 526 counting to n. However, when the count from the counter 516 matches the reference number 520 (such as being within the threshold of the reference number 520), the comparator 518 may generate the mode select signal 522 to indicate that the controller 508 is to switch to the second mode (such as the mode select signal 522 being a logic 1).

In some implementations, the mode select signal 522 indicating that the controller 508 is to switch modes may cause the controller 508 to reduce the energize time of the inductor. For example, the timer 526 may be configured to count to a fraction of n (such as 0.7*n) before the control signal 512 causes switching regulator 402 to transition the inductor from an energize state to a dump state. Referring back to FIG. 6, the second mode inductor energy graph 610 shows that the energize time 614 is reduced when the controller 508 is in the second mode from the energize time 604 when the controller is in the first mode. To note, the amount to reduce the energize time or the dump time (or the maximum current) of the inductor may be any suitable amount, such as being configured by the device manufacturer to ensure that the new switching frequency from the switching regulator is not a frequency to which the device is sensitive.

If the energize time is reduced, the maximum current in the inductor before transitioning from the energize state to the dump state (second mode maximum current 618) is less that the first mode maximum current 608. As such, the energy discharged 632 during one cycle when the controller 508 is in the second mode is less than the energy discharged 622 during one cycle when the controller 508 is in the first mode, and the dump time 616 may be less than the dump time 606. In some implementations, if the energy discharged by the inductor per cycle is reduced, the controller 508 is configured to cause the switching regulator to increase the frequency of charging and discharging the inductor to compensate for the reduced amount of energy discharged per cycle. In a simplified example, if the energy discharged 632 is half of the energy discharged 622 per each respective cycle, the controller 508 may be configured to cause the switching regulator to charge and discharge the inductor twice as much in the second mode than in the first mode (thus doubling the number of cycles for the same amount of time). By increasing the number of cycles in this manner, the total amount of energy discharged by the inductor over time is the same whether the controller is in the first mode or the second mode. To increase the number of cycles, the controller 508 (such as the control signal generator 524) may be configured to cause switch state changes 620 at specific time instances to ensure that the amount of energy discharged by the inductor is the same between modes.

While in the second mode, the controller 508 may be configured to use any suitable means to determine when to transition back to the first mode. In some implementations, the controller 508 may transition back to the first mode after a defined amount of time (such as after 10 seconds or minutes). In some other implementations, the controller 508 may remain in the second mode until powered down, with the controller 508 defaulting back to the first mode at the next startup.

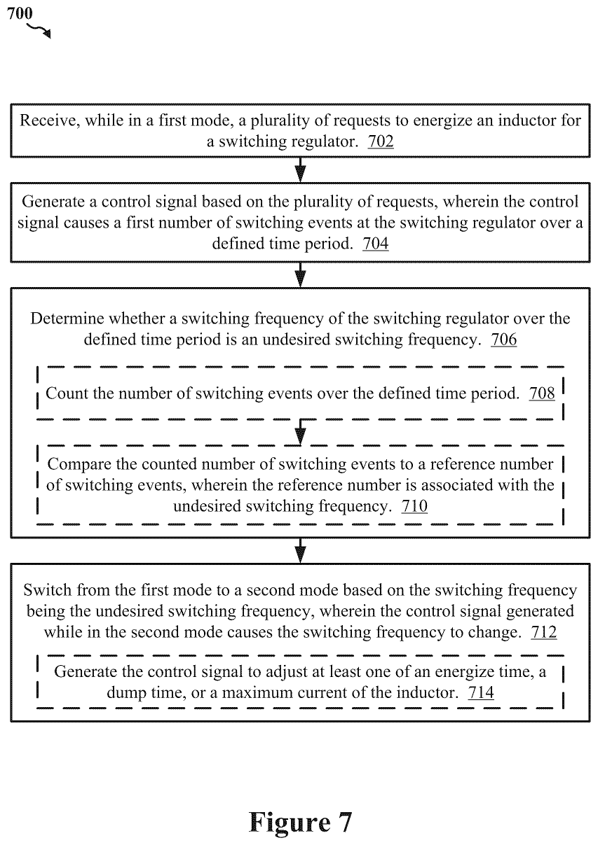

In some implementations, the controller 508 is configured to determine whether the new switching frequency of the switching regulator when the controller 508 is in the second mode is the undesired frequency. For example, a change in frequency in the requests 510 may cause the switching events 514 to occur at the undesired frequency when the controller 508 is in the second mode. The counter 516 may continue to count the number of switching events 514 for each defined time period, and the comparator 518 may continue to compare the count to the reference number 520. If the count matches the reference number 520 (such as being within a threshold), the comparator 518 may generate the mode select signal 522 to indicate that the controller mode is to change. If the controller 508 is in the second mode and the mode select signal 522 indicates that the controller mode is to change, the controller 508 may transition back to the first mode from the second mode. For example, the timer 526 may be configured to again count to n instead of a fraction of n such that switching regulator 402 reverts to conventional operation. A method of operations of the controller 508 to control the switching frequency of the switching regulator 402 is described herein with reference to FIG. 7.

FIG. 7 shows an illustrative flow chart depicting an example operation 700 of a controller controlling a switching regulator. To note, the operations in flowchart 700 are described as being performed with reference to the switching regulator 508 and the switching regulator 402, but any suitable controller to control a suitable discontinuous mode switching regulator configured may be used to perform the operations described herein. As noted above, the controller may be part of the switching regulator, with reference to the switching regulator referring to a portion of the switching regulator, such as the switch matrix.

At 702, the controller 508, while in the first mode, receives a plurality of requests 510 to energize an inductor for a switching regulator 402. The requests 510 may be the conventional requests used for a discontinuous mode switching regulator to cause an inductor to enter into an energize state.

At 704, the controller 508 generates a control signal 512 based on the plurality of requests. The control signal 512 causes a first number of switching events at the switching regulator over a defined time period. In some implementations, while in the first mode, the number of switching events 514 over the defined time period may be equal to the number of requests 510 over the defined time period, thus indicating the number of cycles of charging and discharging of the inductor over the defined time period.

At 706, the controller 508 determines whether a switching frequency of the switching regulator over the defined time period is an undesired switching frequency. As noted above, the undesired switching frequency may be a frequency of ripples at the output supply of the switching regulator to which the device including the switching regulator is sensitive. The undesired switching frequency may be predefined for the device based on testing or observation of the device.

In some implementations of determining whether the switching frequency over the defined time period is the undesired switching frequency, the controller 508 may count (such as by the counter 516) the number of switching events over the defined time period (708), and the controller 508 may compare (such as by the comparator 518) the counted number of switching events to a reference number 520 of switching events (710). The reference number 520 is associated with the undesired switching frequency of the switching regulator. In a simplified example, if an undesired switching frequency is 1 kHz and the defined time period is 10 milliseconds (ms), the reference number may be 10, indicating that the number of switching events 514 during a 10 ms time period is not to be equal to 10 (or within a defined threshold of 10, such as between 9 to 11 or any other suitable threshold).

At 712, the controller 508 switches from the first mode to a second mode based on the switching frequency being the undesired switching frequency. With the controller 508 in the second mode, the control signal 512 generated causes the switching frequency of the switching regulator 402 to change away from the undesired switching frequency. In some implementations, the controller 508 generates the control signal 512 to adjust at least one of an energize time, a dump time, or a maximum current of the inductor for the switching regulator 402 (714). For example, the timer 526 may be adjusted to count to a fraction of n instead of n to cause the switching regulator 402 to reduce the energize time of the inductor.

As noted above, in some implementations, while the controller 508 is in the second mode, the controller 508 may continue to measure the switching events 528 and determine whether the switching frequency of the switching regulator 402 over the defined time period is the undesired switching frequency. If the switching frequency of the switching regulator 402 does match the undesired switching frequency (such as the count of switching events being within a threshold of a reference number associated with the undesired switching frequency) while the controller 508 is in the second mode, the controller 508 may switch back to the first mode from the second mode.

As described above, a controller may be used to prevent a switching regulator from generating interference at an undesired frequency by causing the switching regulator to switch at a different switching frequency. The controller may be implemented in any suitable manner, such as a system on chip (SoC), a circuit on a printed circuit board (PCB), and so on. As noted above, the controller may be included in the switching regulator. However, the controller may be implemented in any other suitable manner.

To note, while some example implementations of a controller are depicted, other controller implementations are covered by the scope of this disclosure. For example, while a controller is depicted as switching between two modes or being based on one undesired frequency, in some implementations, the controller may switch between more than two modes or may prevent the switching regulator from generating interference at more than one undesired frequency. For example, more than one undesired frequency may exist for a device (such as a defined frequency and harmonics of the defined frequency or two unrelated frequencies that may both cause interference). As such, the controller may include more than one comparator to compare a counter's count to more than one reference number. Alternatively, the controller may be reused and provided different threshold inputs associated with the different undesired frequencies to perform a comparison with the counter's count. Each reference number is associated with a different undesired frequency, and each comparator generates a mode select signal to indicate that the controller mode is to be switched. In this manner, the switching regulator may be prevented from switching at more than one undesired switching frequency.

In addition, as used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. For example, while FIGS. 1A-IC depict some simple examples of voltage conversion circuits that may be used by a discontinuous mode switching regulator to regulate a power based on a control signal and one or more switching events, any suitable discontinuous mode switching regulator that charges and discharges an inductor may have the concepts described herein applied. However, exclusively for the sake of clarity in explaining aspects of the present disclosure, the examples herein refer to the example voltage conversion circuits in FIGS. 1A-1C as being included in the example switching regulator. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially claimed as such, one or more features from a claimed combination can In some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example operations in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

What is claimed is:

1. A device, comprising:
a switching regulator to provide power on one or more power rails from one or more power supplies, wherein the switching regulator is a discontinuous mode switching regulator and the switching regulator is associated with an inductor to energize and dump current to maintain a stable voltage for power on the one or more power rails; and
a controller to control the switching regulator, wherein the controller is configured to:
receive, while in a first mode, a plurality of requests to energize the inductor;
generate a control signal based on the plurality of requests, wherein the control signal causes a first number of switching events at the switching regulator over a defined time period;
determine whether a switching frequency of the switching regulator over the defined time period is an undesired switching frequency; and
switch from the first mode to a second mode based on the switching frequency being the undesired switching frequency, wherein the control signal generated by the controller while in the second mode causes the switching frequency of the switching regulator to change.

2. The device of claim 1, wherein the controller, in determining whether the switching frequency over the defined time period is the undesired switching frequency, is configured to:
count the number of switching events over the defined time period; and
compare the counted number of switching events to a reference number of switching events, wherein the reference number is associated with the undesired switching frequency.

3. The device of claim 1, wherein the controller, while in the second mode, is configured to generate the control signal to adjust at least one of an energize time or a dump time of the inductor.

4. The device of claim 3, wherein the controller, while in the second mode, is further configured to:
determine whether the switching frequency of the switching regulator over the defined time period is the undesired switching frequency; and
switch back to the first mode from the second mode based on the switching frequency being the undesired switching frequency.

5. The device of claim 1, wherein the controller, while in the second mode, is configured to generate the control signal to adjust a maximum current of the inductor.

6. The device of claim 5, wherein the controller, while in the second mode, is further configured to:
determine whether the switching frequency of the switching regulator over the defined time period is the undesired switching frequency; and
switch back to the first mode from the second mode based on the switching frequency being the undesired switching frequency.

7. A method of a controller controlling a switching regulator, comprising:
receiving, while in a first mode, a plurality of requests to energize an inductor associated with the switching regulator;
generating a control signal based on the plurality of requests, wherein the control signal causes a first number of switching events at the switching regulator over a defined time period;
determining whether a switching frequency of the switching regulator over the defined time period is an undesired switching frequency; and
switching from the first mode to a second mode based on the switching frequency being the undesired switching frequency, wherein the control signal generated while in the second mode causes the switching frequency to change.

8. The method of claim 7, wherein determining whether the switching frequency over the defined time period is the undesired switching frequency includes:
counting the number of switching events over the defined time period; and
comparing the counted number of switching events to a reference number of switching events, wherein the reference number is associated with the undesired switching frequency

9. The method of claim 7, further comprising, while in the second mode, generating the control signal to adjust at least one of an energize time or a dump time of the inductor.

10. The method of claim 9, further comprising, while in the second mode:
determining whether the switching frequency of the switching regulator over the defined time period is the undesired switching frequency; and
switching back to the first mode from the second mode based on the switching frequency being the undesired switching frequency.

11. The method of claim 7, further comprising, while in the second mode, generating the control signal to adjust a maximum current of the inductor.

12. The method of claim 11, further comprising, while in the second mode:
determining whether the switching frequency of the switching regulator over the defined time period is the undesired switching frequency; and
switching back to the first mode from the second mode based on the switching frequency being the undesired switching frequency.

13. A controller to control a switching a switching regulator, the controller comprising:
an input to receive, while in a first mode, a plurality of requests to energize an inductor associated with a discontinuous mode switching regulator, wherein the inductor is to energize and dump current to maintain a stable voltage for power on the one or more power rails of the discontinuous mode switching regulator;
an output to provide a control signal based on the plurality of requests, wherein the control signal causes a first number of switching events at the discontinuous mode switching regulator over a defined time period; and
a digital logic to:
determine whether a switching frequency of the switching regulator over the defined time period is an undesired switching frequency; and
switch the controller from the first mode to a second mode based on the switching frequency being the undesired switching frequency, wherein the control signal generated by the controller while in the second mode causes the switching frequency of the switching regulator to change.

14. The controller of claim 13, wherein the digital logic includes:
a counter to count the number of switching events over the defined time period; and
a comparator to compare the counted number of switching events to a reference number of switching events, wherein the reference number is associated with the undesired switching frequency.

15. The controller of claim 13, wherein the output is to output the control signal to adjust at least one of an energize time or a dump time of the inductor while the controller is in the second mode.

16. The controller of claim 15, wherein the digital logic is to:
determine whether the switching frequency of the switching regulator over the defined time period is the undesired switching frequency while the controller is in the second mode; and
switch the controller back to the first mode from the second mode based on the switching frequency being the undesired switching frequency.

17. The controller of claim 13, wherein the output is to output the control signal to adjust a maximum current of the inductor while the controller is in the second mode.

18. The controller of claim 17, wherein the digital logic is to:
determine whether the switching frequency of the switching regulator over the defined time period is the undesired switching frequency while the controller is in the second mode; and
switch the controller back to the first mode from the second mode based on the switching frequency being the undesired switching frequency.
